(19) United States
(12) Patent Application Publication
(10) Pub. No.: US 2021/0213379 A1
(43) Pub. Date: Jul. 15, 2021

(54) FILTER MEDIUM COMPRISING ANTIALLERGENIC SUBSTANCES

(71) Applicant: Carl Freudenberg KG, Weinheim (DE)

(72) Inventors: Ilker Uenen, Osthofen (DE); Sascha Blauth, Rodenbach (DE); Uwe Haefner, Kehl (DE)

(21) Appl. No.: 17/129,960

(22) Filed: Dec. 22, 2020

(30) Foreign Application Priority Data
Jan. 9, 2020 (EP) 20150847.0

(51) Int. Cl. B01D 46/00; B32B 5/02; B60H 3/06; B32B 7/12; B32B 5/30

(52) U.S. Cl. CPC B01D 46/0028; B32B 5/022; B60H 3/0608; B32B 7/12; B32B 5/30; B01D 46/0036; B32B 2307/7145; B60H 2003/0691; B32B 2264/108; B32B 2307/728; B32B 2307/73; B32B 2307/724; B01D 46/0038

(57) ABSTRACT

A filter medium includes: a functional layer; and two nonwoven layers. The functional layer is arranged between the nonwoven layers. The functional layer includes antiallergenic substances. The antiallergenic substances comprise a pourable or free-flowing solid. In an embodiment, the solid comprises a granulate. In an embodiment, the antiallergenic substances include polyphenols or fruit acids.

### CROSS-REFERENCE TO PRIOR APPLICATION

Priority is claimed to European Patent Application No. EP 20 150 847.0, filed on Jan. 9, 2020, the entire disclosure of which is hereby incorporated by reference herein.

### FIELD

The invention relates to a filter medium.

The invention also relates to a filter element comprising such a filter medium.

### BACKGROUND

A multilayer filter medium is already known from DE 10 2013 021 071 A1, which filter medium comprises an antiallergenic filter layer, an antimicrobial filter layer, a particulate filter layer, and an odor filter layer. The antiallergenic filter layer is often arranged on the outside of the filter medium to facilitate the release of the antiallergenic substances. A disadvantage in the process is that long-term action of the antiallergenic filter layer is difficult to ensure.

According to the prior art, the antiallergenic layer is produced in that antiallergenic substances via impregnating, coating, padding, spraying, or immersing filter layers. The complicated process technique is thereby disadvantageous.

Another filter medium is described in EP 3 162 425 A1.

### SUMMARY

In an embodiment, the present invention provides a filter medium, comprising: a functional layer; and two nonwoven layers, wherein the functional layer is arranged between the nonwoven layers, wherein the functional layer includes antiallergenic substances, and wherein the antiallergenic substances comprise a pourable or free-flowing solid.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a filter medium comprising a functional layer having antiallergenic substances and two nonwoven layers,

FIG. 2 shows a filter medium comprising a functional layer having antiallergenic and adsorptive substances and two nonwoven layers,

FIG. 3 shows a further embodiment of a filter medium comprising a functional layer having antiallergenic and adsorptive substances and two nonwoven layers, and

FIG. 4 shows a filter element comprising a pleated filter medium.

### DETAILED DESCRIPTION

In an embodiment, the present invention provides a filter medium that exhibits improved antiallergenic properties and is thereby simpler to produce and handle.

In an embodimetn, the present invention provides a filter medium having the features described herein.

According to the invention, it was recognized to be advantageous to provide the antiallergenic substances in the form of a pourable or free-flowing solid:

The filter medium according to the invention has one functional layer and two nonwoven layers, wherein the functional layer is arranged between the two nonwoven layers. A nonwoven material is hereby understood to mean in particular a nonwoven according to the definition of DIN EN ISO 2019-08. The functional layer of the filter medium contains antiallergenic substances. Antiallergenic substances serve, for example, to alter very fine pollen particles and other allergens that cannot be completely retained by the nonwoven layers of the filter medium in such a way that they are innocuous to the human immune system. According to the invention, the antiallergenic substances are introduced into the functional layer in the form of a pourable or free-flowing solid. The pourable or free-flowing solid can be sprinkled in dry during the production of the filter medium. Such a filter medium thus has the advantage of being simple to produce, since the pourable or free-flowing solid is simple to handle. Furthermore, due to the design of the filter medium, the functional layer is protected by the two externally arranged nonwoven layers: A good protection of the functional layer against mechanical stress thus exists. A further advantage of the filter medium according to the invention is a high degree of environmental compatibility and human compatibility, since ingredients of the functional layer cannot escape over the product life cycle, including the disposal of the filter medium. A further advantage results from the fact that the antiallergenic substances can be released slowly and uniformly due to being centrally positioned in the functional layer.

In a particularly advantageous and therefore preferred development of the filter medium according to the invention, the solid is a granulate, also referred to as granular material or a granular medium. A granulate is understood to mean a powder, spherical, particle, dust, or grain form, in particular having a granulate diameter of 200 to 700 μm—also referred to as grain size. Given coarser granulates, a uniform distribution of the antiallergenic substances across the area of the filter medium would no longer be ensured. The antiallergenic substances are present in particular in a concentration of 2-250 g/m², particularly preferably in a concentration of 20-25 g/m² given the use of citric acid. This ensures a good antiallergenic action of the filter medium.

According to a first variant, the antiallergenic substances of the filter medium may contain polyphenols such as catechins, flavonoids, tannins, for example tannic acid. In another variant embodiment, the antiallergenic substances of the filter medium may contain fruit acids, for example citric acid.

In a development of the filter medium according to the invention, the functional layer contains adsorptive substances in the form of a pourable or free-flowing solid, in particular activated carbon. Surprisingly, it has been established that the adsorption capacity of activated carbon, given use of activated carbon mixed with citric acid granulate in a functional layer, is not less than when the activated carbon is used in pure form. By providing adsorptive substances, objectionable or toxic gases may additionally be adsorbed by the filter medium.

The functional layer may also contain substances for scenting the air flow which passes through the filter medium. Such substances may be, for example, citronellal, citronellol, ethylvanillin, and limonene.

If these substances are normally present in liquid form under the climatic operating conditions of the filter medium, they may, for example, be taken up by solids based on, for example, silica gel, zeolites, and superabsorbers, so that the scent is present as a pourable or free-flowing solid.

The functional layer may also contain antimicrobial substances, for example metals or metal compounds, which prevent the filter medium from being affected by microorganisms such as fungi, mold, bacteria, or algae.

Two alternatives are conceivable for the design of the functional layer.

According to a first alternative, the functional layer comprises a layer made of a mixture of antiallergens and adsorptive substances. This means that the pourable or free-flowing solids are present mixed with antiallergenic and adsorptive substance, and together they form a layer that may also be referred to as a substrate layer. In the event that substances for scenting and/or antimicrobial substances are additionally provided, these may likewise be included in the mixture.

In a second variant, the functional layer comprises at least two layers, with one layer made of antiallergenic substances and a further layer made of adsorbent substances. In the event that substances for scenting and/or antimicrobial substances are also provided, these may form part of the functional layer in further layers.

In a development of the filter medium, the substances of the functional layer are bonded to one another and to the nonwoven layers by means of an adhesive. The adhesive may be present, for example, in the form of hot-melt adhesive beads or in the form of fine adhesive threads introduced via spray application.

In a particularly advantageous and therefore preferred development of the filter medium according to the invention, at least one nonwoven layer has a hydrophilic property and/or at least one nonwoven layer has a hydrophobic property. This makes it possible to influence how much, and how quickly, moisture penetrates into the functional layer and releases the antiallergenic substances. A slow and uniform release of the antiallergenic substances may thus be ensured via a corresponding hydrophilic or hydrophobic property of the nonwoven layers. The hydrophilic or hydrophobic properties of the nonwoven layers can be produced by, among other things, the manner of compaction, by means of impregnation, and by a matched choice of material. Nonwovens made of polycarbonate (PC) have hydrophilic properties, and those made of polypropylene (PP) have hydrophobic properties, in particular depending on the water absorption capability of the base material.

The invention also relates to a filter element having a filter medium as described above, which serves for air filtration in a ventilation system of a mobile installation, in particular of a vehicle, a ship, or an aircraft.

The described invention and the described advantageous developments of the invention also represent advantageous developments of the invention in combination with one another, insofar as this is technically reasonable.

The invention will now be explained in more detail using accompanying Figures. Corresponding elements and components are provided with the same reference symbols in the figures. For the sake of better clarity of Figures, a presentation that is true to scale has been dispensed with.

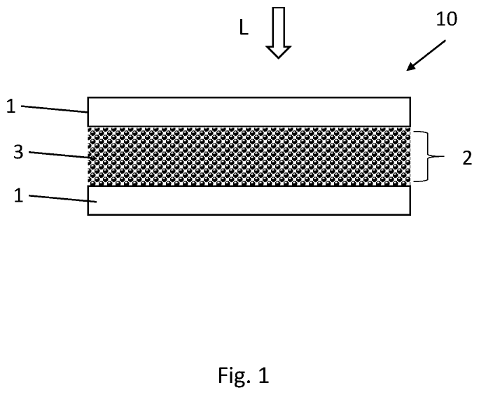

FIG. 1 shows a first embodiment of a filter medium 10 which serves to filter an air flow L. The filter medium 10 has two nonwoven layers 1 and a functional layer 2 arranged between them. The functional layer 2 contains an antiallergenic substance 3 which is present in the form of a pourable or free-flowing solid, namely a granulate.

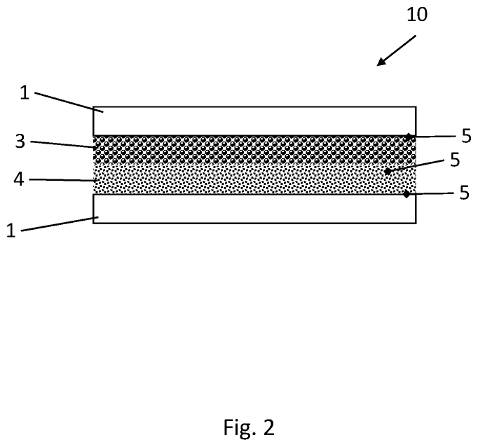

In the embodiment of the filter medium 10 according to FIG. 2, the functional layer 2 comprises two layers, namely a first layer having antiallergenic substances 3 and a second layer having adsorptive substances 4. The adsorptive substances may be activated carbon, for example. The adsorptive substances are also present in the form of a pourable or free-flowing solid, in particular in the form of a granulate. The substances at the functional layer 2 are bonded to one another and to the nonwoven layers 1 by means of adhesive 5.

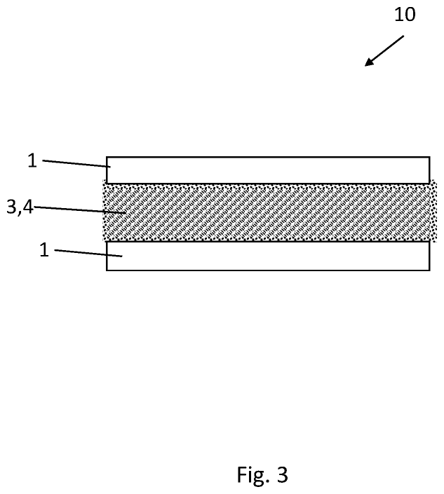

As shown in FIG. 3, the functional layer 2 of the filter medium 10 may comprise a layer made of a mixture of antiallergenic and adsorptive substances 3, 4. The antiallergenic substances 3 and the adsorptive substances 4 together form a substrate layer which is arranged between the nonwoven layers 1.

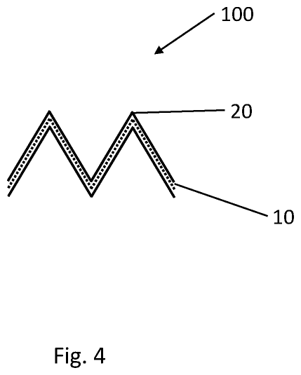

A section from a filter element 100 is shown in FIG. 4. The filter medium 10 has been pleated and provided with fold edges 20 so that this has a larger filtration area. Such a filter element 100 may additionally be provided with edge bands or frames and be used in ventilation systems of mobile installations, for example in vehicles, ships, or aircraft.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Nonwoven layer
2 Functional layer
3 Antiallergenic substance as a granulate
4 Adsorptive substance as a granulate
5 Adhesive
10 Filter medium
20 Fold edge
100 Filter element
L Air flow

What is claimed is:

1. A filter medium, comprising:
a functional layer; and
two nonwoven layers,
wherein the functional layer is arranged between the nonwoven layers,
wherein the functional layer includes antiallergenic substances, and
wherein the antiallergenic substances comprise a pourable or free-flowing solid.

2. The filter medium according to claim 1, wherein the solid comprises a granulate.

3. The filter medium according to claim 1, wherein the antiallergenic substances comprise polyphenols or fruit acids.

4. The filter medium according to claim 1, wherein the functional layer includes adsorptive substances in pourable or free-flowing form, the adsorptive substances comprising activated carbon.

5. The filter element according to claim 1, wherein the functional layer comprises scenting substances.

6. The filter medium according to claim 1, wherein the functional layer comprises antimicrobial substances.

7. The filter medium according to claim 4, wherein the functional layer comprises a layer comprising a mixture of the antiallergenic substances and the adsorptive substances.

8. The filter element according to claim 4, wherein the functional layer comprises two layers, a first layer of the two layers comprising the antiallergenic substances and a second layer of the two layers comprising the adsorptive substances.

9. The filter medium according to claim 1, wherein the antiallergenic substances of the functional layer are bonded to one another and to the two nonwoven layers by adhesive.

10. The filter medium according to claim 1, wherein at least one nonwoven layer of the two nonwoven layers is hydrophilic and/or at least one nonwoven layer of the two nonwoven layers is hydrophobic.

11. A filter element, comprising:
the filter medium according to claim 1 for air filtration in a ventilation system of a mobile installation comprising a vehicle, ship, or aircraft.
